(19) United States
(12) Patent Application Publication
(10) Pub. No.: US 2026/0116146 A1
(43) Pub. Date: Apr. 30, 2026

(54) FULLY AUTOMATIC TEMPERATURE CONTROL SYSTEM AND CONTROL METHOD THEREOF

(71) Applicants: HYUNDAI MOTOR COMPANY, SEOUL (KR); KIA CORPORATION, SEOUL (KR)

(72) Inventors: Qing Dong Hou, Yantai (CN); Tae Hun Jung, Hwaseong-si (KR); Xiao Rui Zhai, Yantai (CN)

(73) Assignees: HYUNDAI MOTOR COMPANY, SEOUL (KR); KIA CORPORATION, SEOUL (KR)

(21) Appl. No.: 19/052,743

(22) Filed: Feb. 13, 2025

(30) Foreign Application Priority Data
Oct. 29, 2024 (CN) 202411524212.X

(51) Int. Cl. B60H 1/00

(52) U.S. Cl. CPC B60H 1/0073; B60H 1/00792; B60H 1/00807; B60H 1/00878; B60H 2001/00733

(57) ABSTRACT

A fully automatic temperature control system includes an ambient temperature sensor and a controller, the ambient temperature sensor being configured to detect an ambient temperature, and the controller being configured to receive a user-set temperature for an air conditioning system from the air conditioning system, receive the detected ambient temperature from the ambient temperature sensor, determine a control mode of the fully automatic temperature control system based on the received set temperature, determine a control temperature based on the set temperature or determine the control temperature based on the set temperature and the ambient temperature, depending on the determined control mode of the fully automatic temperature control system, determine the control temperature as a target temperature of the air conditioning system, and control an operation of the air conditioning system to reach the target temperature.

### CROSS REFERENCE TO RELATED APPLICATIONS

This application claims priority to and the benefit of Chinese Patent Application No. 202411524212.X filed in the Chinese National Intellectual Property Administration on Oct. 29, 2024, the entire contents of which are incorporated herein by reference.

### BACKGROUND

### (a) Field

The present disclosure relates to a fully automatic temperature control system and a control method thereof for controlling a target temperature of an air conditioning system in a stepwise manner within different temperature ranges of a set temperature in the air conditioning system, by considering an influence of ambient temperature on an operation of the air conditioning system.

### (b) Description of the Related Art

A fully automatic temperature control (FATC) system for a vehicle may be a subsystem of an air conditioning system for a vehicle and may automatically adjust a target temperature T_{target} and wind speed of the air conditioning system based on a user-set temperature for the air conditioning system. In general, the air conditioning system may have low (LO) and high (HI) stages. When a user selects the LO or the HI stage, the air conditioning system may be required to cool or heat a vehicle interior as much as possible, thus consuming a lot of energy. Some vehicles do not include the LO and the HI stages of the air conditioning system to improve a driving range of the vehicle (especially an electric vehicle) by preventing energy waste when selecting the LO or the HI stage.

In general, the fully automatic temperature control system may automatically adjust the target temperature T_{target} and the wind speed of the air conditioning system in the following manner. A change amount ΔTₛₑₜ of a set temperature Tₛₑₜ in the air conditioning system may be set to be directly proportional to a change amount ΔT_{inside} of a vehicle interior temperature T_{inside}. That is, ΔTₛₑₜ=k×ΔT_{inside}, where k is a constant. For example, if a user-set temperature Tₛₑₜ for the air conditioning system is changed by 2° C., the fully automatic temperature control system may automatically adjust the target temperature T_{target} and the wind speed of the air conditioning system to enable the vehicle interior temperature T_{inside} to be changed by 3° C. (if k is 1.5). Therefore, if the LO and the HI stages are not set in the air conditioning system, an adjustable range of the vehicle interior temperature T_{inside} may be limited by a range of the set temperature Tₛₑₜ of the air conditioning system.

The range of the set temperature Tₛₑₜ of the air conditioning system may have an upper limit Tᵤₚₚₑᵣ (e.g., 27° C.) and a lower limit T_{lower} (e.g., 17° C.). When an ambient temperature of the air conditioning system is high, if the user-set temperature Tₛₑₜ for the air conditioning system is the upper limit, the vehicle interior temperature T_{inside} may be limited by the upper limit of the set temperature Tₛₑₜ, thus only reaching up to 28° C. to 29° C. and failing to reach a higher temperature. When the ambient temperature is low, if the user-set temperature Tₛₑₜ for the air conditioning system is the lower limit, the vehicle interior temperature T_{inside} may be limited by the lower limit of the set temperature Tₛₑₜ, thus only dropping to 15° C. to 16° C. and failing to reach a lower temperature.

Therefore, if the LO and the HI stages are not set in the air conditioning system, a fully automatic temperature control system in the prior art may fail to heat or cool the vehicle interior to the maximum.

The information disclosed in this Background section is provided only to assist in better understanding of the background of the present disclosure, and may thus include information not included in the prior art already known to those skilled in the art to which the present disclosure pertains.

### SUMMARY

Various aspects of the present disclosure are described to solve the above problems of the prior art, and those skilled in the art will be able to clearly understand other technical problems not mentioned in this document through the detailed description of the specification provided below.

The present disclosure attempts to provide a fully automatic temperature control system and a control method thereof for controlling a target temperature of an air conditioning system in a stepwise manner within different temperature ranges of a set temperature in the air conditioning system, by considering an influence of an ambient temperature.

According to an aspect, provided is a fully automatic temperature control system including: an ambient temperature sensor and a controller, wherein the ambient temperature sensor is configured to detect an ambient temperature, and the controller is configured to receive a user-set temperature for an air conditioning system from the air conditioning system, receive the detected ambient temperature from the ambient temperature sensor, determine a control mode of the fully automatic temperature control system based on the received set temperature, determine a control temperature based on the set temperature or determine the control temperature based on the set temperature and the ambient temperature, depending on the determined control mode of the fully automatic temperature control system, determine the control temperature as a target temperature of the air conditioning system, and control an operation of the air conditioning system to reach the target temperature.

The control mode of the fully automatic temperature control system may include a first control mode, a second control mode, and a third control mode, and the controller may be configured to determine the control temperature in the first control mode based on the set temperature and the ambient temperature, determine the control temperature in the second control mode based on the set temperature, and determine the control temperature in the third control mode based on the set temperature and the ambient temperature.

The controller may be configured to determine the control mode of the fully automatic temperature control system as the first control mode if the received set temperature is lower than a first predetermined temperature, determine the control mode of the fully automatic temperature control system as the second control mode if the received set temperature is higher than or equal to the first predetermined temperature and lower than or equal to a second predetermined temperature, and determine the control mode of the fully automatic temperature control system as the third control mode if the received set temperature is higher than the second predetermined temperature.

The controller may be configured to calculate the control temperature in the first control mode based on the following Equation: T_{control}=(Tₛₑₜ−T₁)×k₁+T₁, where, T_{control} indicates the control temperature, Tₛₑₜ indicates the set temperature, T₁ indicates the first predetermined temperature, and k₁ indicates a first coefficient determined depending on the ambient temperature.

The controller may be configured to calculate the control temperature in the second control mode based on the following Equation: T_{control}=Tₛₑₜ, where, T_{control} indicates the control temperature, and Tₛₑₜ indicates the set temperature.

The controller may be configured to calculate the control temperature in the third control mode based on the following Equation: T_{control}=(Tₛₑₜ−T₂)×k₂+T₂, where, T_{control} indicates the control temperature, Tₛₑₜ indicates the set temperature, T₂ indicates the second predetermined temperature, and k₂ indicates a second coefficient determined depending on the ambient temperature.

According to another aspect, provided is a control method of a fully automatic temperature control system, the method including: receiving, by a controller, a user-set temperature for an air conditioning system from the air conditioning system, receiving, by the controller, an ambient temperature from an ambient temperature sensor, determining, by the controller, a control mode of the fully automatic temperature control system based on the received set temperature, determining, by the controller, a control temperature based on the set temperature or determining the control temperature based on the set temperature and the ambient temperature, depending on the determined control mode of the fully automatic temperature control system, determining, by the controller, the control temperature as a target temperature of the air conditioning system, and controlling an operation of the air conditioning system to reach the target temperature.

The control mode of the fully automatic temperature control system may include a first control mode, a second control mode, and a third control mode, the control temperature in the first control mode may be determined, by the controller, based on the set temperature and the ambient temperature, the control temperature in the second control mode may be determined, by the controller, based on the set temperature, and the control temperature in the third control mode may be determined, by the controller, based on the set temperature and the ambient temperature.

The method may further include: determining, by the controller, the control mode of the fully automatic temperature control system as the first control mode if the received set temperature is lower than a first predetermined temperature, determining, by the controller, the control mode of the fully automatic temperature control system as the second control mode if the received set temperature is higher than or equal to the first predetermined temperature and lower than or equal to a second predetermined temperature, and determining, by the controller, the control mode of the fully automatic temperature control system as the third control mode if the received set temperature is higher than the second predetermined temperature.

The method may further include calculating, by the controller, the control temperature in the first control mode based on the following Equation: T_{control}=(Tₛₑₜ−T₁)×k₁+T₁, where, T_{control} indicates the control temperature, Tₛₑₜ indicates the set temperature, T₁ indicates the first predetermined temperature, and k₁ indicates a first coefficient determined by the ambient temperature.

The method may further include calculating, by the controller, the control temperature in the second control mode based on the following Equation: T_{control}=Tₛₑₜ, where, T_{control} indicates the control temperature, and Tₛₑₜ indicates the set temperature.

The method may further include calculating, by the controller, the control temperature in the third control mode based on the following Equation: T_{control}=(Tₛₑₜ−T₂)×k₂+T₂, where, T_{control} indicates the control temperature, Tₛₑₜ indicates the set temperature, T₂ indicates the second predetermined temperature, and k₂ indicates a second coefficient determined by the ambient temperature.

As set forth above, the fully automatic temperature control system and the control method thereof according to the embodiments of the present disclosure may control the target temperature of the air conditioning system in the stepwise manner in the different temperature ranges of the set temperature in the air conditioning system, by considering the influence of the ambient temperature on the operation of the air conditioning system, thereby improving the cooling performance of the air conditioning system in the low temperature environment and the heating performance of the air conditioning system in the high temperature environment.

Other effects capable of being acquired or predicted by the embodiments of the present disclosure are disclosed directly or implicitly in the detailed description of the embodiments of the present disclosure. That is, various effects predicted based on the embodiments of the present disclosure are disclosed in the detailed description described below.

### BRIEF DESCRIPTION OF THE FIGURES

The above and other purposes, features and other advantages of the present disclosure will be more clearly understood through the detailed description provided below with reference to the accompanying drawings.

FIG. 1 is a block diagram of a fully automatic temperature control system according to an embodiment of the present disclosure.

FIG. 2 is a flow chart showing a control method of a fully automatic temperature control system according to an embodiment of the present disclosure.

FIG. 3 is a graph showing a change in a control temperature of a fully automatic temperature control system that is caused by a change in a set temperature of an air conditioning system.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

Although an embodiment describes that an exemplary process is performed using a plurality of units, it should be understood that the exemplary process may be performed by one or more modules. In addition, it should be understood that a term “controller” refers to a hardware device that includes a memory and a processor. The memory may store a module, and the processor may specifically execute the module to complete one or more processes as further described below.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the description describes a fully automatic temperature control system and a control method thereof according to embodiments of the present disclosure with reference to the accompanying drawings.

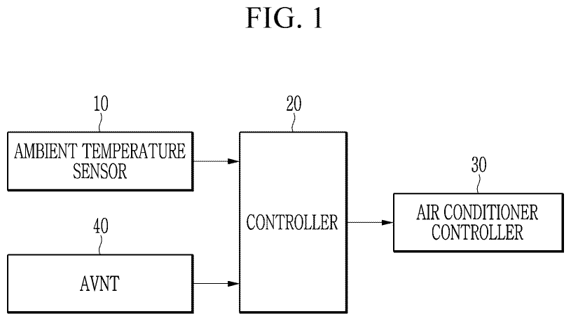

FIG. 1 is a block diagram of a fully automatic temperature control system according to an embodiment of the present disclosure.

As shown in FIG. 1, the fully automatic temperature control system according to an embodiment of the present disclosure may include an ambient temperature sensor 10 and a controller 20. In addition, the controller 20 may communicate with an air conditioner controller 30 and an audio, video, navigation, and telematics (AVNT) system 40 through a vehicle-mounted communication (e.g., controller area network (CAN) communication).

The ambient temperature sensor 10 may be used to detect an ambient temperature T_{amb}. When the ambient temperature T_{amb} is low, heating performance of an air conditioning system may be mainly determined by a vehicle design goal and may be less influenced by the ambient temperature T_{amb}. When the ambient temperature T_{amb} is high, cooling performance of the air conditioning system may be mainly determined by the vehicle design goal and may be less influenced by the ambient temperature T_{amb}. In other words, when the ambient temperature T_{amb} is low, the ambient temperature T_{amb} may mainly influence on the cooling performance of the air conditioning system, and when the ambient temperature T_{amb} is high, the ambient temperature T_{amb} may mainly influence on the heating performance of the air conditioning system.

Here, a case where a user-set temperature Tₛₑₜ for the air conditioning system is lower than a first predetermined temperature T₁ may be defined as a cooling mode of the air conditioning system, and a case where the user-set temperature for the air conditioning system is higher than a second predetermined temperature T₂ may be defined as a heating mode of the air conditioning system.

Therefore, when the ambient temperature T_{amb} is low or high, the fully automatic temperature control system may consider the influence of the ambient temperature T_{amb} on an operation of the air conditioning system, thereby improving the cooling performance and the heating performance of the air conditioning system.

In an embodiment, the controller 20 may be a stand-alone controller. In this case, the controller 20 may receive the ambient temperature T_{amb} detected using the ambient temperature sensor 10 and the AVNT 40 and the user-set temperature Tₛₑₜ for the air conditioning system, respectively, through the vehicle-mounted communication (e.g., CAN communication). In addition, the controller 20 may transmit a control temperature T_{control} (described below in detail) of the fully automatic temperature control system to the air conditioner controller 30 through the vehicle-mounted communication, and use the air conditioner controller 30 to control the operation of the air conditioning system. In one example, the controller 20 may receive the user-set temperature Tₛₑₜ for the air conditioning system from the AVNT 40. In another example, the controller 20 may also receive the user-set temperature Tₛₑₜ for the air conditioning system from an actual button installed in the vehicle.

In another embodiment, the controller 20 may be integrated with the air conditioner controller 30.

The controller 20 may determine a control mode of the fully automatic temperature control system based on the received user-set temperature Tₛₑₜ for the air conditioning system.

In an embodiment, the control mode of the fully automatic temperature control system may include a first control mode, a second control mode, and a third control mode.

The control mode of the fully automatic temperature control system may be classified into the first control mode, the second control mode, and the third control mode based on the user-set temperature Tₛₑₜ for the air conditioning system in order to heat or cool the vehicle interior as much as possible even if the low (LO) and the high (HI) stages are not set in the air conditioning system. Therefore, a target temperature T_{target} of the air conditioning system may be controlled in a stepwise manner within different temperature ranges of the set temperature Tₛₑₜ of the air conditioning system.

In detail, if the received user-set temperature Tₛₑₜ for the air conditioning system is at or near a lower limit of the set temperature Tₛₑₜ for the air conditioning system, this setting indicates that the user's cooling demand is high. Therefore, the fully automatic temperature control system may improve the cooling performance of the air conditioning system by setting the target temperature T_{target} of the air conditioning system to be lower than the user-set temperature Tₛₑₜ for the air conditioning system within the temperature range of the set temperature Tₛₑₜ of the air conditioning system.

If the received user-set temperature Tₛₑₜ for the air conditioning system is at or near an upper limit of the set temperature Tₛₑₜ for the air conditioning system, this setting indicates that the user's heating demand is high. Therefore, the fully automatic temperature control system may improve the heating performance of the air conditioning system by setting the target temperature T_{target} of the air conditioning system to be higher than the user-set temperature Tₛₑₜ for the air conditioning system within the temperature range of the set temperature Tₛₑₜ of the air conditioning system.

For example, the controller 20 may determine the control mode of the fully automatic temperature control system as the first control mode if the received user-set temperature Tₛₑₜ for the air conditioning system is lower than the first predetermined temperature T₁. In the first control mode, the controller 20 may set the target temperature T_{target} of the air conditioning system to be lower than the user-set temperature Tₛₑₜ for the air conditioning system.

The controller 20 may determine the control mode of the fully automatic temperature control system as the second control mode if the received user-set temperature Tₛₑₜ for the air conditioning system is higher than or equal to the first predetermined temperature T₁ and lower than or equal to the second predetermined temperature T₂. In the second control mode, the controller 20 may set the target temperature T_{target} of the air conditioning system to be equal to the user-set temperature Tₛₑₜ for the air conditioning system.

The controller 20 may determine the control mode of the fully automatic temperature control system as the third control mode if the received user-set temperature Tₛₑₜ for the air conditioning system is higher than the second predetermined temperature T₂. In the third control mode, the controller 20 may set the target temperature T_{target} of the air conditioning system to be higher than the user-set temperature Tₛₑₜ for the air conditioning system.

Preferably, the first predetermined temperature T₁ may be 20° C., and the second predetermined temperature T₂ may be 24° C.

After determining the control mode of the fully automatic temperature control system, the controller 20 may calculate the control temperature T_{control} of the fully automatic temperature control system based on the ambient temperature T_{amb} and the set temperature Tₛₑₜ of the air conditioning system, depending on the determined control mode.

In detail, in the first control mode, the controller 20 may calculate the control temperature T_{control} of the fully automatic temperature control system based on Equation 1 below.

$${T}_{control} = ( {T}_{set} - {T}_{1} ) \times {k}_{1} + {T}_{1} . \qquad Equation 1$$

Here, T_{control} indicates the control temperature of the fully automatic temperature control system, Tₛₑₜ indicates the set temperature of the air conditioning system, T₁ indicates the first predetermined temperature, and k₁ indicates a first coefficient determined depending on the ambient temperature T_{amb}.

Table 1 below shows a mapping relationship between the first coefficient k₁ and the ambient temperature T_{amb}.

TABLE 1

| T_{amb} (° C.) | −40 | −30 | −20 | −10 | −5 | 0 | 5 |
|---|---|---|---|---|---|---|---|
| k₁ | 1 | 1 | 1 | 3.0 | 2.7 | 2.5 | 2.3 |

| T_{amb} (° C.) | 10 | 15 | 20 | 25 | 30 | 40 | 50 |
|---|---|---|---|---|---|---|---|
| k₁ | 1.8 | 1.3 | 1 | 1 | 1 | 1 | 1 |

As shown in Table 1, the value of the first coefficient k₁ may be 1 if the ambient temperature T_{amb} is lower than −10° C. The value of the first coefficient k₁ may be increased as the ambient temperature T_{amb} is decreased if the ambient temperature T_{amb} is greater than or equal to −10° C. and less than 20° C. The value of the first coefficient k₁ may be 1 if the ambient temperature T_{amb} is greater than or equal to 20° C.

The first coefficient k₁ may reflect a magnitude of the influence of the ambient temperature T_{amb} on the control temperature T_{control} of the fully automatic temperature control system. When the ambient temperature T_{amb} is within a range of −10° C. to 20° C., if the user-set temperature Tₛₑₜ for the air conditioning system is the same as the ambient temperature T_{amb}, the lower the ambient temperature T_{amb}, the greater a difference between the control temperature T_{control} of the fully automatic temperature control system and the set temperature Tₛₑₜ of the air conditioning system (that is, an absolute value of the difference between the control temperature T_{control} of the fully automatic temperature control system and the set temperature Tₛₑₜ of the air conditioning system may be large). Therefore, the cooling performance of the air conditioning system in a low temperature environment may be effectively improved.

Table 1 only shows some first coefficients k₁ that correspond to the ambient temperature T_{amb}, and the other first coefficients k₁ that correspond to the ambient temperature T_{amb} may be calculated using linear interpolation.

For example, when the ambient temperature T_{amb} is −8° C., the controller 20 may determine that the ambient temperature T_{amb} is within a temperature range of −10° C. to −5° C., and correspondingly, the value of the first coefficient k₁ is within a range of 3.0 to 2.7. Within the range of 3.0 to 2.7, the value of the first coefficient k₁ that corresponds to the ambient temperature T_{amb} of −8° C. may be calculated using the linear interpolation. Therefore, the first coefficient k₁ may be calculated as k₁=(2.7−3.0)/((−5)−(−10))×((−8)−(−10))+3.0=2.88.

After calculating the first coefficient k₁, the controller 20 may calculate the control temperature T_{control} of the fully automatic temperature control system based on Equation 1.

For example, if the user-set temperature Tₛₑₜ for the air conditioning system is 19° C., based on the received set temperature Tₛₑₜ of the air conditioning system and the calculated first coefficient k₁, the controller 20 may then calculate the control temperature T_{control} of the fully automatic temperature control system as T_{control}=(19−20)×2.88+20=17.12° C., which is lower than the user-set temperature Tₛₑₜ for the air conditioning system.

After calculating the control temperature T_{control} of the fully automatic temperature control system, the controller 20 may transmit the determined control temperature T_{control} to the air conditioner controller 30 through the vehicle-mounted communication, thus determining the control temperature T_{control} as the target temperature T_{target} of the air conditioning system, and controlling the operation of the air conditioning system to reach the target temperature T_{target}.

In the first control mode, the air conditioning system may be operated at a temperature lower than the set temperature Tₛₑₜ as the target temperature T_{target}, thus expanding a low temperature adjustment range for the vehicle interior temperature of the fully automatic temperature control system.

In the second control mode, the controller 20 may calculate the control temperature T_{control} of the fully automatic temperature control system based on Equation 2 below.

$${T}_{control} = {T}_{set} . \qquad Equation 2$$

Here, T_{control} indicates the control temperature, and Tₛₑₜ indicates the set temperature of the air conditioning system.

In the second control mode, the air conditioning system may be operated at the set temperature Tₛₑₜ as the target temperature T_{target}.

In the third control mode, the controller 20 may calculate the control temperature T_{control} of the fully automatic temperature control system based on Equation 3 below.

$${T}_{control} = ( {T}_{set} - {T}_{2} ) \times {k}_{2} + {T}_{2} . \qquad Equation 3$$

Here, T_{control} indicates the control temperature of the fully automatic temperature control system, Tₛₑₜ indicates the set temperature of the air conditioning system, T₂ indicates the second predetermined temperature, and k₂ indicates a second coefficient determined depending on the ambient temperature T_{amb}.

Table 2 below shows a mapping relationship between a value of the second coefficient k₂ and the ambient temperature T_{amb}.

TABLE 2

| T_{amb} (° C.) | −40 | −30 | −20 | −10 | −5 | 0 | 5 |
|---|---|---|---|---|---|---|---|
| k₂ | 1 | 1 | 1 | 1 | 1.5 | 2.0 | 2.5 |

| T_{amb} (° C.) | 10 | 15 | 20 | 25 | 30 | 40 | 50 |
|---|---|---|---|---|---|---|---|
| k₂ | 2.7 | 3.2 | 3.7 | 1 | 1 | 1 | 1 |

As shown in Table 2, the second coefficient k₂ may be 1 if the ambient temperature T_{amb} is lower than or equal to −10° C. The value of the second coefficient k₂ may be increased as the ambient temperature T_{amb} is increased if the ambient temperature T_{amb} is greater than −10° C. and less than or equal to 20° C. The value of the second coefficient k₂ may be 1 if the ambient temperature T_{amb} is greater than 20° C.

The second coefficient k₂ may reflect a magnitude of the influence of the ambient temperature T_{amb} on the control temperature T_{control} of the fully automatic temperature control system. When the ambient temperature T_{amb} is within a range of 10° C. to 20° C., if the user-set temperature Tₛₑₜ for the air conditioning system is the same as the ambient temperature T_{amb}, the higher the ambient temperature T_{amb}, the greater the difference between the control temperature T_{control} of the fully automatic temperature control system and the set temperature Tₛₑₜ of the air conditioning system. Therefore, the heating performance of the air conditioning system in a high temperature environment may be effectively improved.

Table 2 only shows some second coefficients k₂ that correspond to the ambient temperature T_{amb}, and the other second coefficients k₂ that correspond to the ambient temperature T_{amb} may be calculated using the linear interpolation.

For example, when the ambient temperature T_{amb} is 8° C., the controller 20 may determine that the ambient temperature T_{amb} is within a temperature range of 5° C. to 10° C., and correspondingly, the second coefficient k₂ is within a range of 2.5 to 2.7. Within the range of 2.5 to 2.7, the second coefficient k₂ that corresponds to the ambient temperature T_{amb} of 8° C. may be calculated using the linear interpolation. Therefore, the second coefficient k₂ may be calculated as k₂=(2.7−2.5)/(10−5)×(8−5)+2.5=2.62.

After calculating the second coefficient k₂, the controller 20 may calculate the control temperature T_{control} of the fully automatic temperature control system based on Equation 3.

For example, if the user-set temperature Tₛₑₜ for the air conditioning system is 25° C., based on the received set temperature Tₛₑₜ of the air conditioning system and the calculated second coefficient k₂, the controller 20 may then calculate the control temperature T_{control} of the fully automatic temperature control system as T_{control}=(25−24)×2.62+24=26.62° C., which is higher than the user-set temperature Tₛₑₜ for the air conditioning system.

After calculating the control temperature T_{control} of the fully automatic temperature control system, the controller 20 may transmit the determined control temperature T_{control} to the air conditioner controller 30 through the vehicle-mounted communication, thus determining the control temperature T_{control} as the target temperature T_{target} of the air conditioning system, and controlling the operation of the air conditioning system to reach the target temperature T_{target}.

In the third control mode, the air conditioning system may be operated at a temperature higher than the set temperature Tₛₑₜ as the target temperature T_{target}, thus expanding a high temperature adjustment range for the vehicle interior temperature of the fully automatic temperature control system.

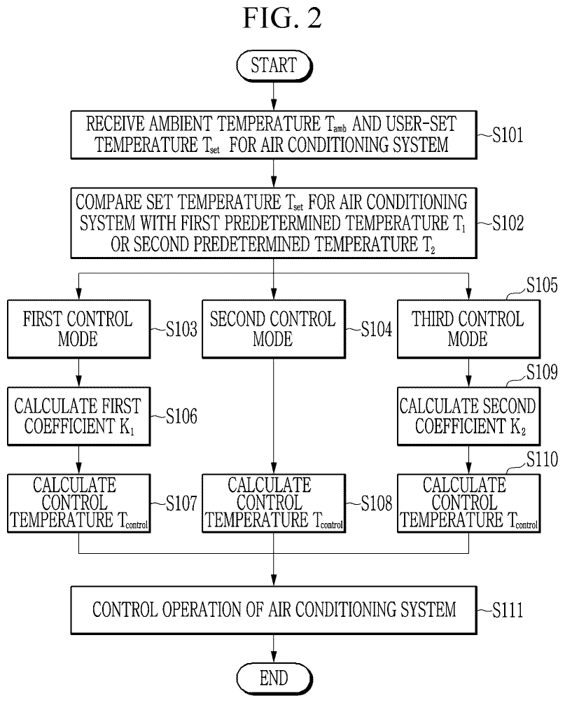

FIG. 2 is a flow chart showing a control method of a fully automatic temperature control system according to an embodiment of the present disclosure. The fully automatic temperature control system shown in FIG. 1 may execute steps S101 to S111 of the control method described below.

As shown in FIG. 2, in step S101, the controller 20 may receive the ambient temperature T_{amb} detected using the ambient temperature sensor 10 and the AVNT 40 and the user-set temperature Tₛₑₜ for the air conditioning system, respectively, through the vehicle-mounted communication (e.g., CAN communication). In one example, the controller 20 may receive the user-set temperature Tₛₑₜ for the air conditioning system from the AVNT 40. In another example, the controller 20 may also receive the user-set temperature Tₛₑₜ for the air conditioning system from the actual button installed in the vehicle.

In step S102, the controller 20 may determine the control mode of the fully automatic temperature control system by comparing the received user-set temperature Tₛₑₜ for the air conditioning system with the first predetermined temperature T₁ or the second predetermined temperature T₂.

In detail, in step S103, the controller 20 may determine the control mode of the fully automatic temperature control system as the first control mode if the received set temperature Tₛₑₜ is lower than the first predetermined temperature T₁.

In step S104, the controller 20 may determine the control mode of the fully automatic temperature control system as the second control mode if the received user-set temperature Tₛₑₜ for the air conditioning system is higher than or equal to the first predetermined temperature T₁ and lower than or equal to the second predetermined temperature T₂.

In step S105, the controller 20 may determine the control mode of the fully automatic temperature control system as the third control mode if the received user-set temperature Tₛₑₜ for the air conditioning system is higher the second predetermined temperature T₂.

When the control mode of the fully automatic temperature control system is determined as the first control mode, in step S106, the controller 20 may calculate the first coefficient k₁ that corresponds to the ambient temperature T_{amb} by using the linear interpolation, based on Table 1 above.

After calculating the first coefficient k₁, in step S107, the controller 20 may calculate the control temperature T_{control} of the fully automatic temperature control system based on the set temperature Tₛₑₜ of the air conditioning system and the first coefficient k₁ by using Equation 1 above.

After calculating the control temperature T_{control} of the fully automatic temperature control system, in step S111, the controller 20 may transmit the determined control temperature T_{control} to the air conditioner controller 30 through the vehicle-mounted communication, thus determining the control temperature T_{control} as the target temperature T_{target} of the air conditioning system, and controlling the operation of the air conditioning system to reach the target temperature T_{target}.

When the control mode of the fully automatic temperature control system is determined as the second control mode, in step S108, the controller 20 may calculate the control temperature T_{control} of the fully automatic temperature control system based on the set temperature Tₛₑₜ of the air conditioning system by using Equation 2 above.

After calculating the control temperature T_{control} of the fully automatic temperature control system, in the step S111, the controller 20 may transmit the determined control temperature T_{control} to the air conditioner controller 30 through the vehicle-mounted communication, thus determining the control temperature T_{control} as the target temperature T_{target} of the air conditioning system, and controlling the operation of the air conditioning system to reach the target temperature T_{target}.

When the control mode of the fully automatic temperature control system is determined as the third control mode, in step S109, the controller 20 may calculate the second coefficient k₂ that corresponds to the ambient temperature T_{amb} by using the linear interpolation, based on Table 2 above.

After calculating the second coefficient k₂, in step S110, the controller 20 may calculate the control temperature T_{control} of the fully automatic temperature control system based on the set temperature Tₛₑₜ of the air conditioning system and the second coefficient k₂ by using Equation 3 above.

After calculating the control temperature T_{control} of the fully automatic temperature control system, in the step S111, the controller 20 may transmit the determined control temperature T_{control} to the air conditioner controller 30 through the vehicle-mounted communication, thus determining the control temperature T_{control} as the target temperature T_{target} of the air conditioning system, and controlling the operation of the air conditioning system to reach the target temperature T_{target}.

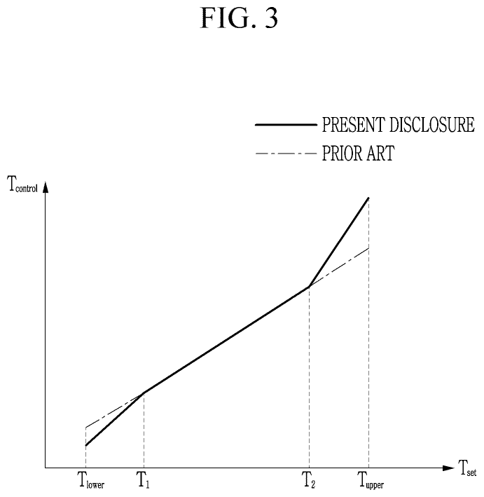

FIG. 3 is a graph showing a change in the control temperature of the fully automatic temperature control system that is caused by a change in the set temperature Tₛₑₜ of the air conditioning system. Here, a solid line indicates a curve showing the change in the control temperature of the fully automatic temperature control system according to the embodiment of the present disclosure that is caused by the change in the set temperature Tₛₑₜ of the air conditioning system when the ambient temperature T_{amb} is 15° C.; and a dotted line indicates a curve showing a change in a control temperature of a prior fully automatic temperature control system that is caused by a change in a set temperature Tₛₑₜ of the air conditioning system.

As shown by the dotted line in FIG. 3, in the prior fully automatic temperature control system, a rate of the change in the control temperature of the fully automatic temperature control system that is caused by the change in the set temperature Tₛₑₜ of the air conditioning system may not be changed regardless of the temperature range of the set temperature Tₛₑₜ of the air conditioning system is, and the rate of change may constantly be 1. Therefore, the prior fully automatic temperature control system may not heat or cool the vehicle interior to the maximum extent.

On the other hand, as shown by the solid line in FIG. 3, in the fully automatic temperature control system according to an embodiment of the present disclosure, a rate of the change in the control temperature T_{control} of the fully automatic temperature control system that is caused by the change in the set temperature Tₛₑₜ of the air conditioning system may be the first coefficient k₁ if the set temperature Tₛₑₜ of the air conditioning system is lower than the first predetermined temperature T₁. If the set temperature Tₛₑₜ of the air conditioning system is higher than or equal to the first predetermined temperature T₁ and lower than or equal to the second predetermined temperature T₂, the rate of change in the control temperature T_{control} of the fully automatic temperature control system according to the change of the set temperature Tₛₑₜ of the air conditioning system may be 1. If the set temperature Tₛₑₜ of the air conditioning system is higher than the second predetermined temperature T₂, the rate of change in the control temperature T_{control} of the fully automatic temperature control system that is caused by the change of the set temperature Tₛₑₜ of the air conditioning system may be the second coefficient k₂.

When the ambient temperature T_{amb} is 15° C., the first coefficient k₁ may be 1.3 based on Table 1, and the second coefficient k₂ may be 3.2 based on Table 2.

Within a first temperature range from a lower limit T_{lower} of the set temperature Tₛₑₜ in the air conditioning system to the first predetermined temperature T₁, the control temperature T_{control} of the fully automatic temperature control system according to an embodiment of the present disclosure may reach a lower temperature than the control temperature T_{control} of the prior fully automatic temperature control system. Therefore, compared to the prior art, the fully automatic temperature control system according to the embodiment of the present disclosure may expand the low temperature adjustment range for the vehicle interior temperature.

Within a second temperature range from the first predetermined temperature T₁ to the second predetermined temperature T₂, the control temperature T_{control} of the fully automatic temperature control system according to an embodiment of the present disclosure may be the same as the control temperature T_{control} of the prior fully automatic temperature control system.

Within a third temperature range from the second predetermined temperature T₂ to an upper limit Tᵤₚₚₑᵣ of the set temperature Tₛₑₜ in the air conditioning system, the control temperature T_{control} of the fully automatic temperature control system according to an embodiment of the present disclosure may reach a higher temperature than the control temperature T_{control} of the conventional fully automatic temperature control system. Therefore, compared to the prior system, the fully automatic temperature control system according to the embodiment of the present disclosure may expand the high temperature adjustment range for the vehicle interior temperature.

Therefore, compared to the prior fully automatic temperature control system, the fully automatic temperature control system according to an embodiment of the present disclosure may improve the cooling performance and heating performance of the air conditioning system.

As set forth above, the fully automatic temperature control system and the control method thereof according to the embodiments of the present disclosure may control the target temperature of the air conditioning system in the stepwise manner in the different temperature ranges of the set temperature in the air conditioning system, by considering the influence of the ambient temperature on the operation of the air conditioning system, thereby improving the cooling performance of the air conditioning system in the low temperature environment and the heating performance of the air conditioning system in the high temperature environment.

The descriptions of the specific embodiments described above are provided to describe and illustrate the present disclosure. The above description is not intended to be exhaustive or to limit the present disclosure to an exact form in which the present disclosure is disclosed, and it is clear that minor modifications and variations are all possible in accordance with the suggestions provided above. The present disclosure is described by selecting the embodiments to interpret the specific principles and their practical applications, and others skilled in the art may thus utilize and implement the various embodiments of the present disclosure and various alternative and modified forms. The scope of the present disclosure is limited to the appended claims and their equivalent forms.

1. A fully automatic temperature control system comprising:
an ambient temperature sensor and a controller,
wherein the ambient temperature sensor is configured to detect an ambient temperature; and
wherein the controller is configured to:
receive a user-set temperature for an air conditioning system from the air conditioning system;
receive the detected ambient temperature from the ambient temperature sensor;
determine a control mode of the fully automatic temperature control system based on the received user-set temperature;
determine a control temperature based on the user-set temperature or determine the control temperature based on the user-set temperature and the ambient temperature, depending on the determined control mode of the fully automatic temperature control system;
determine the control temperature as a target temperature of the air conditioning system; and
control an operation of the air conditioning system to reach the target temperature.

2. The system of claim 1, wherein:
the control mode of the fully automatic temperature control system includes a first control mode, a second control mode, and a third control mode; and
the controller is further configured to:
determine the control temperature in the first control mode based on the set temperature and the ambient temperature;
determine the control temperature in the second control mode based on the set temperature; and
determine the control temperature in the third control mode based on the set temperature and the ambient temperature.

3. The system of claim 2, wherein the controller is further configured to:
determine the control mode of the fully automatic temperature control system as the first control mode when the received set temperature is lower than a first predetermined temperature;
determine the control mode of the fully automatic temperature control system as the second control mode when the received set temperature is higher than or equal to the first predetermined temperature and lower than or equal to a second predetermined temperature; and
determine the control mode of the fully automatic temperature control system as the third control mode when the received set temperature is higher than the second predetermined temperature.

4. The system of claim 3, wherein the controller is further configured to:
calculate the control temperature in the first control mode based on
$${T}_{control} = ( {T}_{set} - {T}_{1} ) \times {k}_{1} + {T}_{1} ,$$
where, T_{control} indicates the control temperature, Tₛₑₜ indicates the set temperature, T₁ indicates the first predetermined temperature, and k₁ indicates a first coefficient determined depending on the ambient temperature.

5. The system of claim 3, wherein the controller is further configured to:
calculate the control temperature in the second control mode based on
$${T}_{control} = {T}_{set} ,$$
where, T_{control} indicates the control temperature, and Tₛₑₜ indicates the set temperature.

6. The system of claim 3, wherein the controller is further configured to:
calculate the control temperature in the third control mode based on
$${T}_{control} = ( {T}_{set} - {T}_{2} ) \times {k}_{2} + {T}_{2} ,$$
where, T_{control} indicates the control temperature, Tₛₑₜ indicates the set temperature, T₂ indicates the second predetermined temperature, and k₂ indicates a second coefficient determined depending on the ambient temperature.

7. A control method of a fully automatic temperature control system, the method comprising:
receiving, by a controller, a user-set temperature for an air conditioning system from the air conditioning system;
receiving, by the controller, an ambient temperature from an ambient temperature sensor;
determining, by the controller, a control mode of the fully automatic temperature control system based on the received user-set temperature;
determining, by the controller, a control temperature based on the user-set temperature or determining the control temperature based on the user-set temperature and the ambient temperature, depending on the determined control mode of the fully automatic temperature control system;
determining, by the controller, the control temperature as a target temperature of the air conditioning system, and controlling an operation of the air conditioning system to reach the target temperature.

8. The method of claim 7, wherein:
the control mode of the fully automatic temperature control system includes a first control mode, a second control mode, and a third control mode;
the control temperature in the first control mode is determined, by the controller, based on the set temperature and the ambient temperature;
the control temperature in the second control mode is determined, by the controller, based on the set temperature; and
the control temperature in the third control mode is determined, by the controller, based on the set temperature and the ambient temperature.

9. The method of claim 8, further comprising:
determining, by the controller, the control mode of the fully automatic temperature control system as the first control mode when the received set temperature is lower than a first predetermined temperature;
determining, by the controller, the control mode of the fully automatic temperature control system as the second control mode when the received set temperature is higher than or equal to the first predetermined temperature and lower than or equal to a second predetermined temperature; and
determining, by the controller, the control mode of the fully automatic temperature control system as the third control mode when the received set temperature is higher than the second predetermined temperature.

10. The method of claim 9, further comprising calculating, by the controller, the control temperature in the first control mode based on
$${T}_{control} = ( {T}_{set} - {T}_{1} ) \times {k}_{1} + {T}_{1} ,$$
where, T_{control} indicates the control temperature, Tₛₑₜ indicates the set temperature, T₁ indicates the first predetermined temperature, and k₁ indicates a first coefficient determined by the ambient temperature.

11. The method of claim 9, further comprising calculating, by the controller, the control temperature in the second control mode based on
$${T}_{control} = {T}_{set} ,$$
where, T_{control} indicates the control temperature, and Tₛₑₜ indicates the set temperature.

12. The method of claim 9, further comprising calculating, by the controller, the control temperature in the third control mode based on
$${T}_{control} = ( {T}_{set} - {T}_{2} ) \times {k}_{2} + {T}_{2} ,$$
where, T_{control} indicates the control temperature, Tₛₑₜ indicates the set temperature, T₂ indicates the second predetermined temperature, and k₂ indicates a second coefficient determined by the ambient temperature.
